(19) United States
(12) Patent Application Publication
(10) Pub. No.: US 2025/0356493 A1
(43) Pub. Date: Nov. 20, 2025

(54) TECHNIQUE FOR ANOMALY DETECTION IN MEDICAL IMAGES

(71) Applicant: Siemens Healthineers AG, Forchheim (DE)

(72) Inventors: Vasile George Marica, Bucharest (RO); Manuela Daniela Voinea, Brasov (RO); Oladimeji Farri, Upper Saddle River, NJ (US)

(21) Appl. No.: 19/203,714

(22) Filed: May 9, 2025

(30) Foreign Application Priority Data
May 15, 2024 (DE) 10 2024 113 543.3
May 15, 2024 (EP) 24465521.3

(51) Int. Cl. G06T 7/00

(52) U.S. Cl. CPC G06T 7/0016; G06T 2207/20024; G06T 2207/20081; G06T 2207/20084; G06T 2207/30096

(57) ABSTRACT

Systems and methods for generating a comparison database and its use in a downstream neural network for anomaly detection in medical images. A set of medical images with annotations is received and filtered for a subset with a decisive detection, determined by an anomaly detection algorithm, of a (non-) existence of anomalies, congruently with the annotation. The filtered set is augmented using a first and a second auto-encoder-decoder by optimizing a distance between encoded states of pairs of medical images. The distance is maximized (or minimized) for positive (or negative) pairs having the same (or disjoint) decisively detected (non-) existence of anomalies before encoding and/or after decoding the encoded state using the first (or second) auto-encoder-decoder. A probability of a (non-) existence of an anomalies is determined. The encoded states of the augmented set are stored along with the determined probabilities.

### CROSS REFERENCE TO RELATED APPLICATIONS

This application claims the benefit of DE 10 2024 113 543.3, filed on May 15, 2024, and EP 24465521.3 filed on May 15, 2024, both of which are hereby incorporated by reference in their entirety.

### FIELD

Embodiments relate to a technique for generating a comparison database for use in a downstream neural network (NN) for anomaly detection in medical images received from a medical scanner.

### BACKGROUND

Chest X-rays are a commonly performed diagnostic imaging procedure, conducted millions of times worldwide each year. However, interpreting these X-rays is a highly subjective and intricate task in radiology, with varying levels of agreement among different readers. The degree of agreement, measured by a kappa value, ranges from 0.2 to 0.77, depending on factors like the reader's experience, the specific abnormality being identified, and the clinical environment (Moncada, 2011), (Hopstaken, 2004).

Radiologists encounter difficulties in analyzing extensive patient health data promptly. This is due to the complexity of interpreting X-ray images, where overlapping tissues and low contrast resolutions often lead to missed detections and diagnoses.

Using deep learning (DL) techniques for medical image analysis presents various challenges. In chest X-ray classification, one notable challenge arises from imbalanced datasets, leading to inaccurate results. Additionally, class imbalance may contribute to model overfitting (Jaiswal, 2019).

Radiologists reviewing chest X-rays have access to essential clinical information, including the patient's medical history, symptoms, and often additional data from tests like blood work. This comprehensive information aids radiologists not only in identifying visible abnormalities (e.g., consolidation) but also in deducing their likely causes (e.g., pneumonia). By integrating data from multiple sources alongside the chest X-ray image, the radiologist may enhance his or her sensitivity and specificity, reducing the risk of blindly following algorithms suggesting inaccurate labels that do not align with external data sources.

Transfer learning (Yang, 2020) is a widely used technique in radiology, particularly in chest X-ray analysis. It involves leveraging pre-trained models, originally developed for tasks like ImageNet (Deng, 2009) classification, and adapting them for medical image analysis (Hashmi, 2020), (Apostolopoulos, 2020), (Farooq, 2020). This approach offers two methods: feature extraction (Yang, 2020), where the pre-trained model's lower layers are kept fixed, and fine-tuning (Yang, 2020), where some layers are adjusted for specific medical tasks. Transfer learning may significantly improve model performance, particularly when dealing with limited medical data. However, it requires pre-training on similar datasets and careful consideration of learning rates for optimal results.

Image segmentation (Sultana, 2020), the process of dividing digital images into fragments, is valuable in medical image analysis (Bhattacharya, 2021). For instance, in (Narayanan, 2020), the authors applied transfer learning with various models to detect pneumonia in chest X-ray images, achieving high accuracy, especially with the InceptionV 3 model. They also introduced a CNN architecture for distinguishing bacterial from viral pneumonia, using image segmentation with a U-Net architecture based on lung masks from the Shenzhen Dataset (Candemir, 2014), (Jaeger, 2014). This segmentation significantly improved accuracy.

(LaLonde, 2018) introduced a convolutional-deconvolutional capsule network for lung segmentation, enhancing results while reducing parameters. Their model achieved an accuracy of 98.47% in lung segmentation. Similarly, (Bonheur, 2019) proposed “Matwo-CapsNet,” a semantic segmentation network based on capsule network concepts, extending previous work.

Ensemble classification (Chollet, 2021) combines multiple models to improve accuracy and reliability by reducing prediction variability. (Hashmi, 2020) used a weighted classifier with five models for pneumonia classification, achieving 98.43% accuracy. (Chouhan, 2020) used majority voting with five models for 96.4% accuracy. (Pant, 2020) combined U-Nets based on ResNet-34 and EfficientNet-B4, reaching 90% accuracy. (Hilmizen, 2020) experimented with various model combinations and achieved 99.87% accuracy by concatenating ResNet-50 and VGG-16.

Many deep neural network architectures have been employed in image classification studies. VGG, ResNet, Inception, MobileNet, DenseNet, CapsNet, U-Net, EfficientNet, and SqueezeNet have all been used for tasks like pneumonia and COVID-19 detection in chest X-rays. These models have achieved varying levels of accuracy, often surpassing 90% accuracy in their respective applications.

However, it remains an open problem that conventional image analysis methods provide in many cases uncertain disease labeling and/or abnormality detection.

### BRIEF SUMMARY AND DESCRIPTION

Embodiments provide a (for example automated and/or real-time) solution for an improved prediction on the existence and non-existence of anomalies from medical images, for example those which conventionally are considered not sufficiently decisive or clear. Embodiments may further (time-efficiently) integrate (for example in an automated manner) medical data from multiple resources for medical image analysis in view of potential anomalies.

Embodiments provide a method of generating a comparison database for use in a downstream NN for anomaly (also: abnormality) detection in medical images received from a medical scanner, by a method of performing, by a downstream NN, anomaly detection in medical images received from a medical scanner using the generated comparison database, by a method of training a downstream NN for performing anomaly detection in medical images received from a medical scanner, by two (e.g., auto-) encoder-decoders, by a computing device, by a downstream NN, by a system including the downstream NN, by a computer program (and/or computer program product) and by a computer-readable storage medium (also: memory).

Embodiments are described with respect to the claimed methods as well as with respect to the (e.g., auto-) encoder-decoders, computing device and downstream NN. Features, advantages or alternative embodiments herein may be assigned to the other objects (e.g., the computer program or a computer program product) and vice versa. In other words, embodiments for the (e.g., auto-) encoder-decoders, computing device and downstream NN may be improved with features described or claimed in the context of the methods. In this case, the functional features of the method are embodied by structural units of the system and vice versa, respectively.

As to a first method aspect, a (for example computer-implemented) method of generating a comparison database for use in a downstream neural network (NN) for anomaly detection in medical images received from a medical scanner is provided. The method includes a step of receiving a set of medical images. Each medical image within the set includes an annotation. The method further includes a step of filtering the received set of medical images for a subset of medical images with a decisive detection of an existence and non-existence of anomalies for a set of anomaly classes. The decisive detection is determined by an anomaly detection algorithm congruently with the received annotation. The method further includes a step of augmenting the filtered set of medical images using two (e.g., auto-) encoder-decoders by optimizing a distance between encoded states of pairs of medical images within the filtered set. The optimizing of the distance of the encoded states includes maximizing, using a first (e.g., auto-) encoder-decoder, the distance for positive pairs of medical images having the same decisively detected existence and non-existence of anomalies before encoding and/or after decoding the encoded state. The optimizing of the distance of the encoded states further includes minimizing, using a second (e.g., auto-) encoder-decoder, the distance for negative pairs of medical images having disjoint decisively detected existences of anomalies before encoding and/or after decoding the encoded state. It may further be required that any medical image within a negative pair has (e.g., only) decisively determined non-existences of anomalies (e.g., for no anomaly within the set of anomaly classes, the anomaly detection algorithm is non-decisive and/or ambiguous). The augmenting further includes determining a probability of an existence or non-existence of an anomaly for each anomaly class from the decoding of the encoded state. The method further includes a step of storing the encoded states of the augmented set of medical images along with the determined (e.g., decisive) probabilities of existences and non-existences of anomalies for generating the comparison database.

An improved anomaly detection in medical images (e.g., caused by pneumonia and/or COVID-19, e.g., derived from X-ray chest images) and related diagnosis, for example in the presence of overlapping tissues and/or low contrast resolution, is thus provided. The improvement may advantageously include both an accuracy (and/or reliability) and a time-efficiency.

By the generated comparison database, for example imbalanced datasets (e.g., for training a downstream NN for anomaly detection and/or diagnostic support) may be compensated, and/or an overfitting may be avoided.

Embodiments aim at solving the issue of uncertain disease labelling (and/or abnormality detection) by using for example contrastive learning, optionally in conjunction with a (e.g., large language model, LLM) generative task using related (and/or similar) medical (e.g., radiology) findings (e.g., from medical reports, vital functions, laboratory results and/or further medical images such as historic and/or previous medical images of the same patient) as input.

For example, by using the comparison database for anomaly detection in medical images, an accuracy and reliability of the anomaly detection may be improved and a prediction variability may be reduced. By the computer implementation, the anomaly detection may further be performed in a time-efficient manner, for example for real-time application, such as during a medical consultation. Thereby, a need for follow-up visits and/or follow-up dates for performing further medical imaging may be avoided.

The medical scanner may make use of a predetermined imaging modality (e.g., X-ray imaging, also: radiography; and/or magnetic resonance tomography, MRT) and/or may provide images of a predetermined anatomical area (e.g., the chest).

The annotation may include an image classification, an image segmentation, and/or text indicative of an existence or non-existence of an anomaly per anomaly class. The annotation may, e.g., be provided by a medical expert. Alternatively, or in addition, the annotation may be obtained at least semi-automatically (e.g., based on an automated segmentation, the medical expert may determine the existence of an anomaly).

Alternatively, or in addition, the annotation may include a kappa value, which conventionally measures how often multiple medical experts (also: clinicians), examining the same patients (or the same imaging results), agree that a particular finding (e.g., an anomaly) is present (also: existent) or absent (also: non-existent).

The set of anomaly classes may include multiple anomaly classes, for example per anatomical region. Alternatively, or in addition, an anomaly class may include a tumor, a lesion, and/or an alteration of a type and/or density of tissue. E.g., anomalies that may exist and/or may be detectable in chest images (and/or images including the lungs) may include pneumonia, a mass, atelectasis, consolidation, edema, emphysema and/or fibrosis. Chest images (and/or images including the lungs) may, e.g., be acquired by radiography.

Alternatively, or in addition, anomalies that may exist and/or may be detectable in chest images (and/or images including the heart) may include a myocardial infarct (also: heart attack), cardiomyopathy, valve disorders, congenital heart defects, pericardial diseases, a mass (and/or tumor), and/or coronary artery disease. Chest images (and/or images including the heart) may, e.g., be acquired by MRT, e.g., as a two-dimensional (2D) slice.

Further alternatively or in addition, anomalies that may exist and/or may be detectable in brain images may include an aneurysm, a focal point (and/or or indication) of epilepsy, a mass (e.g., tumor), white matter hyperintensities, anomalous calcifications, and/or a (e.g., chronic) brain infarct. Brain images may, e.g., be acquired by MRT, e.g., as a two-dimensional (2D) slice.

The anomaly detection algorithm may be configured to determine a value of a probability of an existence or non-existence of an anomaly per anomaly class. A decisive detection may include the determined probability value exceeding (and/or reaching) a high (and/or detection) threshold, e.g., at least 90% (and for example 95%). A decisive non-detection may include the determined probability value undercutting (and/or reaching) a low (and/or non-detection) threshold, e.g., 10% (and for example 5%).

The first (e.g., auto-) encoder-decoder (also: positive-pair, e.g., auto-, encoder-decoder) and/or the second (e.g., auto-) encoder-decoder (also: negative-pair, e.g., auto-, encoder-decoder) may be trained (and/or continue to be trained) using inverse contrastive learning for generating (and/or augmenting; also: enhancing) the comparison database.

Conventional contrastive learning involves training a model to differentiate between similar and dissimilar pairs of data points by maximizing their similarity within the same (and/or positive) class and minimizing it between different (and/or negative) classes. By contrast, the first (e.g., auto-) encoder-decoder minimizes the similarity (and/or maximizes the distance) between positive pairs of encoded states, and the second (e.g., auto-) encoder-decoder maximize the similarity (and/or minimizes the distance) between negative pairs of encoded states.

An encoded state (also: encoded representation, encoded embedding, latent space, and/or state in feature space) may be the output of the encoder of an (e.g., auto-) encoder-decoder. Alternatively, or in addition, the encoded state may be a compressed state and/or a condensed state (e.g., including less Bytes than the medical image, on which it is based).

The first (e.g., auto-) encoder-decoder and/or the second (e.g., auto-) encoder-decoder may be (e.g., continuously) fine-tuned for improved inverse contrastive learning and/or for modifying encoded states (for example by the encoder of the corresponding, e.g., auto-, encoder-decoder) complying with decisive anomaly detection results of the related decoded images (for example provided by the decoder of the corresponding (e.g., auto-) encoder-decoder).

The generated comparison database may be used for transfer learning for anomaly detection in medical images by a downstream NN.

The method may further include a step of augmenting the set of medical images. The augmenting of the set of medical images may include, for any medical image within the set adding noise, and/or performing at least one geometric transformation. The at least one geometric transformation may include flipping the medical image (e.g., horizontally and/or vertically), rotating the medical image (e.g., by 90 degrees), cropping the medical image, and/or re-scaling (briefly also: scaling) the medical image. Scaling may include changing an image size (e.g., in terms of a digital data volume and/or resolution).

The step of augmenting of set of medical images by adding noise and/or performing one or more geometric transformations may be performed externally (e.g., before the set of medical images is received by a computing device). Alternatively, or in addition, the step of augmenting of set of medical images by adding noise and/or performing one or more geometric transformations may be performed on the received set of medical images before the step of filtering.

By the augmenting of the set of medical images by adding noise and/or performing geometric transformations, a flexibility and/or effectiveness of the two (e.g., auto-) encoder-decoders may be improved.

Filtering the received set of medical images may include applying the anomaly detection algorithm to each received medical image within the set. The applied anomaly detection algorithm may determine a probability of an existence or non-existence of an anomaly for each anomaly class within a predetermined set of anomaly classes. The filtering of the received set of medical images may further include selectively retaining a medical image if the determined probability of the applied anomaly detection algorithm is decisive. The probability being decisive may include, for each anomaly class within the predetermined set of anomaly classes, a probability of the existence of an anomaly reaching and/or being above a predetermined high threshold (e.g., at and/or above 95% probability). Alternatively, or in addition, the probability being decisive may include, for each anomaly class within the predetermined set of anomaly classes, a probability of the non-existence of an anomaly reaching and/or being below a predetermined low threshold (e.g., at and/or below 5% probability). The filtering may require a (e.g., independent and/or separate) decisive determination for each anomaly class.

The filtering of the received set of medical images may further include comparing, for each retained (e.g., by the determination by the anomaly detection algorithm being decisive for each anomaly class) medical image, the detected existences and non-existences of anomalies for each anomaly class within the predetermined set of anomaly classes with the received annotation (e.g., without an assigned probability and/or with statements like “anomaly—e.g., an abnormal mass-exists” only). The filtering of the received set of medical images may further include selectively retaining each medical image, for which the result of the comparing is consensual for each anomaly class.

Alternatively, or in addition, the filtering of the received set of medical images may include an optional grouping of the retained medical images according to their detected existences and non-existences of anomalies into positive pairs of identical decisively detected existences of one or more anomalies (for example obtained by the anomaly detection algorithm and confirmed by the annotation).

The comparison database may be composed of groups, each having the same detected existences of some anomalies and non-existences of the other anomalies within the set of anomaly classes.

Some of the groups may be disjoint in terms of each detected existence of an anomaly. Any negative pair of medical images (and/or their encoded states) may correspond to one medical image selected from a first group and a second medical image being selected from a second group that is disjoint from the first group in terms of each detected existence of an anomaly (and/or anomaly class). Alternatively, or in addition, any positive pair may include two medical images (and/or their encoded states) within the same group (e.g., the first group).

The step of augmenting the filtered set of medical images may include training the two (e.g., auto-) encoder-decoders for optimizing the distances between the encoded states of each pair.

The first (e.g., auto-) encoder-decoder may be trained to modify an encoded state, such that a distance with respect to a reference encoded state is maximized, while a result of detecting the existences and non-existences of anomalies remains unchanged (e.g., up to fluctuations in the corresponding probability values within the limits of the high and low thresholds, such as changing from 95% to 96%, and/or from 5% to 4%, for the decoded image obtained from the modified encoded state).

The second (e.g., auto-) encoder-decoder may be trained to modify an encoded state, such that a distance with respect to a reference encoded state is minimized, while a result of detecting the existences and non-existences of anomalies remains unchanged (e.g., up to fluctuations in the corresponding probability values within the limits of the high and low thresholds, such as changing from 95% to 96%, and/or from 5% to 4%, for the decoded image obtained from the modified encoded state).

Each encoder-decoder may be an auto-encoder-decoder, for example configured to reconstruct the same medical image.

The medical images may be two-dimensional (2D) images and/or 2D slices of volumetric images (also denoted as three-dimensional, 3D, images).

The medical images may be planar images and/or may include planar slices of volumetric images.

The medical images may include a predetermined anatomical area, e.g., a (for example human) chest and/or (for example human) brain. The anatomical detection algorithm may be configured for detecting anomalies in relation to the predetermined anatomical area and/or one or more organs located within the predetermined anatomical area (e.g., the lung being located in the chest area).

The medical images may be acquired in relation to a human (e.g., patient) or an animal (e.g., a mammal, such as a horse).

The medical images, for which the anomaly detection is to be performed, may be acquired by radiography (also: X-ray imaging); ultrasound (US), for example echocardiography; scintigraphy; optical coherence tomography (OCT); magnetic resonance tomography (MRT); computed tomography (CT); positron emission tomography (PET); and/or single-photon emission computed tomography (SPECT).

X-ray images and US images may be acquired as 2D images.

Scintigraphy (also: gamma scan) is a diagnostic test in nuclear medicine, where radioisotopes attached to drugs that travel to a specific organ or tissue (radiopharmaceuticals) are taken internally, and the emitted gamma radiation is captured by gamma cameras, which are external detectors that form two-dimensional images in a process similar to the capture of X-ray images.

OCT, MRT, CT, PET and/or SPECT images may be acquired as volumetric images, from which a 2D slice may be used (and/or selected). In some embodiments, for OCT, MRT, CT, PET and/or SPECT images, the technique may be repeated for several 2D slices within the same volumetric image. E.g., an extension of an anomaly may thereby be estimated and/or detected.

The distance between encoded states may be determined by a similarity metric. The similarity metric may include a mean squared error (MSE) between the pairs of encoded states.

The similarity metric (also: similarity measure) may alternatively or in addition include a structural similarity, for example a Structural Similarity Index Measure (SSIM) and/or a Deep Image Structure and Texture Similarity (DISTS). Alternatively, or in addition, peak signal-to-noise ratio (PSNR) and/or no-reference image quality assessment metrics such as Blind/Referenceless Image Spatial Quality Evaluator (BRISQUE) and/or Natural Image Quality Evaluator (NIQE) may be used.

The method may further include a step of providing the generated comparison database, for example to a downstream NN, for performing an anomaly detection task.

The method may be performed by a computing device.

As to a second method aspect, a (for example computer-implemented) method of performing, by a downstream NN, anomaly detection in medical images received from a medical scanner using the comparison database generated according to the first method aspect is provided.

The method includes a step of receiving a medical image from a medical scanner. The method further includes a step of performing (also: executing) the anomaly detection algorithm on the received medical image. The method further includes a step of selectively encoding the medical image twice using the first (e.g., auto-) encoder-decoder and the second (e.g., auto-) encoder-decoder. The selectively encoding is (e.g., only) performed if a result of performing the anomaly detection algorithm is non-decisive (also: not conclusive and/or ambiguous).

The method further includes a step of determining, for the encoded state of the medical image using the first auto-encoder, the stored encoded state within the comparison database with the closest probabilities of an existence of anomalies. The method further includes a step of determining, for the encoded state of the medical image using the second auto-encoder, the stored encoded state within the comparison database with the closest probabilities of a non-existence of anomalies from the comparison database. The method still further includes a step of assigning, based on the probabilities of an existence and non-existence of anomalies of the determined stored encoded states, an existence and non-existence of anomalies to the received medical image.

The result of the anomaly detection algorithm being non-decisive (also: ambiguous) may include a result falling within a range between the low threshold and the high threshold (e.g., including a 60% detection probability of an anomaly with a high threshold of 90% or 95% and a low threshold of 10% or 5% for decisiveness).

The closest encoded states from the comparison database may be closest in terms of a set of values of detection probabilities (e.g., averaged over all probabilities of the anomaly classes).

Alternatively, or in addition, the closest encoded states from the comparison database may be determined based on a distance of the encoded states.

The assigning of the existence or non-existence of an anomaly to the received medical image may include performing a weighting, e.g., of the probabilities of the closest positive-pair encoded state and the closest negative-pair encoded state.

The method may further include a step of outputting (e.g., on a graphical user interface, GUI, and/or a display) the assigned existence and non-existence of anomalies in relation to the received medical image.

The method of performing the anomaly detection, which is executed by a downstream NN, may make use of the method of generating the comparison database according to the first method aspect.

Alternatively, or in addition, the method of performing the anomaly detection, which is executed by a downstream NN, may further use one or more additional digital datasets indicative of a patient's health state and/or relevant to the anomaly detection. The one or more additional digital datasets may for example include text dataset (e.g., medical reports, values of measured vital signs and/or laboratory values). The step of determining assigning an existence and non-existence of anomalies to the received medical image may by further based on the one or more additional digital datasets. E.g., NLP and/or a LLM may be used to improve the accuracy of the assignment.

As to a third method aspect, a (for example computer-implemented) method of training a downstream NN for anomaly detection in medical images received from a medical scanner using the method according to the second method aspect is provided. In the training phase, in the step of receiving the medical image, annotations in relation to the medical image are received as ground truth. The medical image and annotation may be included in a training dataset received from a storage of a training database (e.g., instead of directly from a medical scanner). The step of assigning the existence and non-existence of anomalies to the received medical image may be followed by a step of comparing the assigned existence and non-existence of anomalies with the received annotations (and/or the ground truth).

The annotations may include text (e.g., included in a medical imaging report, such as a radiology report, and/or associated laboratory report). E.g., the annotations may include a (for example medical practitioner's) diagnosis of an existence of one or more anomalies. Alternatively, or in addition, the annotations may include clinical indicators (such as characteristic laboratory values, e.g., above or below a normal, and/or healthy, range) and/or characteristic combinations of clinical indicators for the existence of an anomaly within a particular anomaly class. Further alternatively or in addition, the annotations may include a patient's medical history, symptoms and/or blood work results.

The downstream NN may include a Large Language Model (LLM), for example for performing the assigning of the existence and non-existence of anomalies. Training the downstream NN may for example include training the LLM using the annotations and Ground Truth.

Comparing the assigned existence and non-existence of anomalies with the received annotations (and/or the Ground Truth) may include determining at least one value of a loss function. Training the downstream NN may include optimizing the (e.g., at least one value of the) loss function.

As to a first device aspect, a first (e.g., auto-) encoder-decoder is provided. The first (e.g., auto-) encoder-decoder may be trained for maximizing a distance of positive pairs of medical images, for which the same existence and non-existence of anomalies for any anomaly class within a set of anomaly classes has been decisively detected before encoding and/or after decoding the encoded states.

As to a second device aspect, a second (e.g., auto-) encoder-decoder is provided. The second (e.g., auto-) encoder-decoder may be trained for minimizing a distance of negative pairs of medical images, for which disjoint existences of anomalies have been decisively detected before encoding and/or after decoding the encoded state.

As to a third device aspect, a computing device for generating a comparison database for use in a downstream NN for anomaly detection in medical images received from a medical scanner is provided. The computing device includes a medical image reception interface configured for receiving a set of medical images. Each medical image within the set includes an annotation. The computing device further includes a filtering module configured for filtering the received set of medical images for a subset of medical images with a decisive detection of an existence and non-existence of anomalies for a set of anomaly classes. The decisive detection is determined by an anomaly detection algorithm congruently with the received annotation. The computing device further includes an augmenting module configured for augmenting the filtered set of medical image by optimizing a distance between encoded states of pairs of medical images within the filtered set. The augmenting module includes a first (e.g., auto-) encoder-decoder interface to a first (e.g., auto-) encoder-decoder (e.g., according to the first device aspect) configured for maximizing the distance for positive pairs of medical images having the same decisively detected existence and non-existence of anomalies before encoding and/or after decoding the encoded state. The augmenting module further includes a second (e.g., auto-) encoder-decoder interface to a second (e.g., auto-) encoder-decoder (e.g., according to the second device aspect) configured for minimizing the distance for negative pairs of medical images having disjoint decisively detected existences of anomalies before encoding and/or after decoding the encoded state. The augmenting further includes determining a probability of an existence or non-existence of an anomaly for each anomaly class from the decoding of the encoded state. The computing device further includes a computer-readable storage (also: memory) configured for storing the encoded states of the augmented set of medical images along with the determined probabilities of existences and non-existences of anomalies as a generated comparison database.

The computing device may be configured for performing any one of the steps of the method. Alternatively, or in addition, the computing device may include any one of the features disclosed in the context of the method.

As to a fourth device aspect, a downstream neural network (NN) is provided for performing anomaly detection in medical images received from a medical scanner using the comparison database generated by the computing device according to the third device aspect (and/or generated according to the first method aspect). The downstream NN includes a medical image reception interface configured for receiving a medical image from a medical scanner. The downstream NN further includes an anomaly detection algorithm performing module configured for performing the anomaly detection algorithm on the received medical image. The downstream NN further includes a first interface to a first (e.g., auto-) encoder-decoder (e.g., according to the first device aspect) and a second interface to a second (e.g., auto-) encoder-decoder (e.g., according to the second device aspect). The first interface and the second interface are configured for receiving a selectively encoded medical image from the first (e.g., auto-) encoder-decoder and from the second (e.g., auto-) encoder-decoder, respectively. The selectively encoding is (e.g., only) performed if a result of performing the anomaly detection algorithm is non-decisive. The downstream NN further includes a closest encoded state determining module configured for determining, for the encoded state of the medical image using the first auto-encoder, the stored encoded state within the comparison database with the closest probabilities of an existence of anomalies, and for the encoded state of the medical image using the second auto-encoder, the stored encoded state within the comparison database with the closest probabilities of a non-existence of anomalies from the comparison database. The downstream NN still further includes an anomaly existence assignment module configured for assigning, based on the probabilities of an existence and non-existence of anomalies of the determined stored encoded states, an existence and non-existence of anomalies to the received medical image.

The downstream NN may be configured to perform the method according to the second method aspect. Alternatively or in addition, the downstream NN may be trained by the method according to the third method aspect.

In an embodiment, the downstream NN may include the first (e.g., auto-) encoder-decoder (e.g., according to the first device aspect) and the second (e.g., auto-) encoder-decoder (e.g., according to the second device aspect), e.g., with the first interface and the second interface being internal interfaces within the downstream NN.

As to a system aspect, a system for performing anomaly detection in medical images received from a medical scanner is provided. The system includes a first (e.g., auto-) encoder-decoder (e.g., according to the first device aspect), a second (e.g., auto-) encoder-decoder (e.g., according to the second device aspect), a downstream NN (e.g., according to the fourth device aspect) and an interface to at least one medical scanner. Alternatively, or in addition, in case the first (e.g., auto-) encoder-decoder (e.g., according to the first device aspect) and the second (e.g., auto-) encoder-decoder (e.g., according to the second device aspect) are include in the downstream NN, the system includes further the interface to the at least one medical scanner.

The system may be configured to perform any one of the steps, or include any one of the features described in the context of the methods.

As to a further aspect, a computer program product is provided. The computer program product includes program elements which induce a computing device to carry out the steps of the method of generating a comparison database for use in a downstream NN for anomaly detection in medical images received from a medical scanner according to the first method aspect, when the program elements are loaded into a memory of the computing device. Alternatively or in addition, the computer program product includes program elements which induce a downstream NN to carry out the steps of the method of performing anomaly detection in medical images received from a medical scanner using the generated comparison database according to the second method aspect, and/or the method of training a downstream NN for performing anomaly detection in medical images received from a medical scanner using the method according to third method aspect when the program elements are loaded into a memory of the downstream NN.

As to a still further aspect, a computer-readable medium is provided. On the computer-readable medium, program elements are stored that may be read and executed by a computing device, in order to perform the steps of generating a comparison database for use in a downstream NN for anomaly detection in medical images received from a medical scanner according to the first method aspect, when the program elements are executed by the computing device. Alternatively or in addition, program elements are stored that may be read and executed by a downstream NN, in order to perform steps of the method of performing anomaly detection in medical images received from a medical scanner using the generated comparison database according to the second method aspect, and/or the method of training a downstream NN for performing anomaly detection in medical images received from a medical scanner using the method according to third method aspect, when the program elements are executed by the downstream NN.

The properties, features and advantages described above, as well as the manner they are achieved, become clearer and more understandable in the light of the following description and embodiments, which will be described in more detail in the context of the drawings.

This following description does not limit the embodiment on the contained embodiments. Same components or parts may be labeled with the same reference signs in different figures. In general, the figures are not for scale.

These and other aspects will be apparent from and elucidated with reference to the embodiments described hereinafter.

### BRIEF DESCRIPTION OF THE DRAWINGS

FIG. 1 depicts a flow chart of a method of generating a comparison database for use in a downstream neural network (NN) for anomaly detection in medical images received from a medical scanner according to an embodiment.

FIG. 2 depicts a flow chart of a method of performing, by a downstream NN, anomaly detection in medical images received from a medical scanner using the generated comparison database according to an embodiment.

FIG. 3 depicts a flow chart of a method of training a downstream NN for performing anomaly detection in medical images received from a medical scanner according to an embodiment.

FIG. 4 depicts an overview of the structure and architecture of a computing device according to an embodiment, wherein the computing device may be configured for performing the method of FIG. 1.

FIG. 5 depicts an overview of the structure and architecture of a downstream NN according to an embodiment, wherein the downstream NN may be trained by the method of FIG. 3 and/or may be configured to perform the method of FIG. 2

FIG. 6 depicts a schematic illustration of recovering an original medical image as output of an (e.g., auto-) encoder-decoder, into which geometrically transformed versions of the medical image were input according to an embodiment.

FIG. 7 depicts a schematic for determining a stored encoded state and/or medical image with the closest probabilities of existences and non-existences of anomalies according to an embodiment.

FIG. 8 schematically depicts the filtering a set of medical images by firstly only retaining the medical images with an algorithmically (and/or automatically) determined decisive detection of existences and non-existences of anomalies and secondly only retaining those medical images, for which a (for example manual) annotation agrees with the decisive detection according to an embodiment.

### DETAILED DESCRIPTION

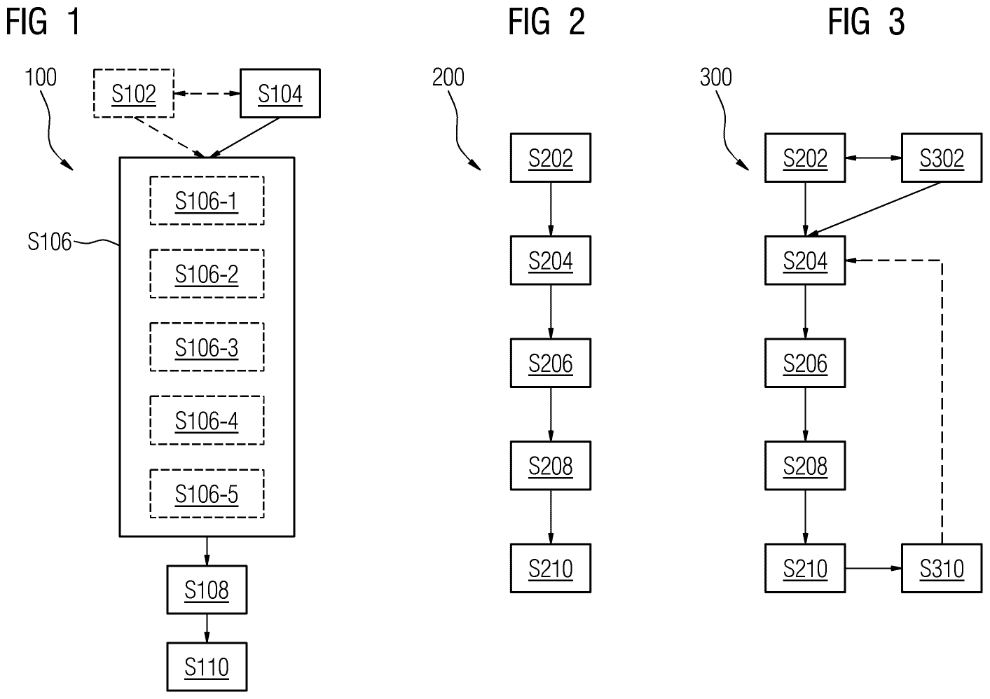

FIG. 1 schematically depicts an exemplary flowchart for a method of generating a comparison database for use in a downstream neural network (NN) for anomaly detection in medical images received from a medical scanner. The method is generally referred to by the reference sign 100.

The method 100 includes a step S104 of receiving a set of medical images. Each medical image within the set includes an annotation.

The method 100 further includes a step S106 of filtering the received S104 set of medical images for a subset of medical images with a decisive detection of an existence and non-existence of anomalies for a set of anomaly classes. The decisive detection is determined by an anomaly detection algorithm congruently (also: concordantly, coherently and/or consistently) with the received S104 annotation.

The method 100 further includes a step S108 of augmenting the filtered S106 set of medical images using two (e.g., auto-) encoder-decoders by optimizing a distance between encoded states of pairs of medical images within the filtered S106 set.

The optimizing of the distance of the encoded states includes maximizing (for example using a first (e.g., auto-) encoder-decoder) the distance for positive pairs of medical images having the same decisively detected existence and non-existence of anomalies before encoding and/or after decoding the encoded state. Alternatively or in addition, the optimizing of the distance of the encoded states includes minimizing (for example using a second (e.g., auto-) encoder-decoder) the distance for negative pairs of medical images having disjoint decisively detected existences of anomalies before encoding and/or after decoding the encoded state.

The augmenting S108 further includes determining a probability of an existence or non-existence of an anomaly for each anomaly class from the decoding of the encoded state.

The method 100 further includes a step S110 of storing the encoded states of the augmented S108 set of medical images along with the determined probabilities of existences and non-existences of anomalies for generating the comparison database.

Optionally, the method 100 includes a step S102 of (e.g., firstly) augmenting the set of medical images. The augmenting S102 may include (for example for any medical image within the set independently) adding noise, and/or performing at least one geometric transformation. The at least one geometric transformation may include flipping the medical image horizontally, flipping the medical image vertically, rotating the medical image by an angle (e.g., by 90 degrees), cropping the medical image, and/or re-scaling the medical image.

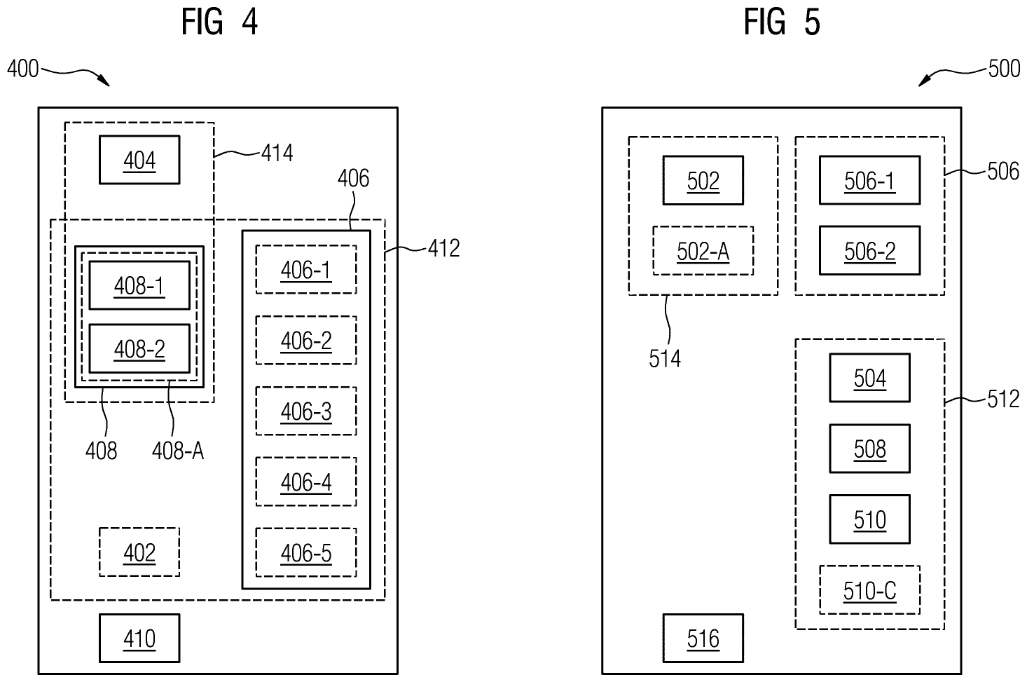

The step S102 of (e.g., firstly) augmenting the set of medical images may in one embodiment precede the step S104 of receiving the set of medical images. E.g., the set of medical images may be augmented outside of a computing device (e.g., the device 400 of FIG. 4). Alternatively or in addition, the step S102 of (e.g., firstly) augmenting the set of medical images may be performed after the step S104 of receiving the set of medical images (e.g., the first augmenting may be performed by the computing device 400).

The step S106 of filtering the received S104 set of medical images may include a sub-step S106-1 of applying the anomaly detection algorithm to each received S104 medical image within the set. The applied S106-1 anomaly detection algorithm may determine a probability of an existence or non-existence of an anomaly for each anomaly class within a predetermined set of anomaly classes.

The step S106 of filtering the received S104 set of medical images may alternatively or in addition include a sub-step S106-2 of selectively retaining each medical image if the determined probability of the applied S106-1 anomaly detection algorithm is decisive. The probability being decisive may include, for each anomaly class within the predetermined set of anomaly classes, a probability of the existence of an anomaly reaching or being above a predetermined high threshold (e.g., at least and/or above a probability of 95%). Alternatively or in addition, the probability being decisive may include, for each anomaly class within the predetermined set of anomaly classes, a probability of the non-existence of an anomaly reaching or being below a predetermined low threshold (e.g., at most and/or below a probability of 5%).

The step S106 of filtering the received S104 set of medical images may alternatively or in addition include a sub-step S106-3 of comparing, for each retained S106-2 medical image, the detected existences and non-existences of anomalies for each anomaly class within the predetermined set of anomaly classes with the received S104 annotation.

The step S106 of filtering the received S104 set of medical images may alternatively or in addition include a sub-step S106-4 of selectively retaining each medical image, for which the result of the comparing S106-3 is consensual for each anomaly class.

The step S106 of filtering the received S104 set of medical images may alternatively or in addition include an optional sub-step S106-5 of grouping the retained S106-4 medical images according to their detected existences and non-existences of anomalies into positive pairs of identical decisively detected existences of one or more anomalies.

The method 100 may further include a step (not shown in FIG. 1) of providing the generated comparison database to a downstream NN for performing the anomaly detection.

The method 100 may be performed by a computing device (e.g., the computing device 400 of FIG. 4).

FIG. 2 schematically depicts an exemplary flowchart for a method of performing, by a downstream NN, anomaly detection in medical images received from a medical scanner using a comparison database (e.g., generated according to the method 100 of FIG. 1). The method is referred to by the reference sign 200.

The method 200 includes a step S202 of receiving a medical image, for example from a medical scanner (e.g., in the inference phase).

The method 200 further includes a step S204 of performing the anomaly detection algorithm on the received S202 medical image.

The method 200 further includes a step S206 of selectively encoding the medical image twice using the first (e.g., auto-) encoder-decoder and the second (e.g., auto-) encoder-decoder. The selectively encoding S206 is performed (e.g., only) if a result of performing S204 the anomaly detection algorithm is non-decisive.

The method 200 further includes a step S208 of determining, for the encoded S206 state of the medical image using the first auto-encoder, the stored S110 encoded state within the comparison database with the closest probabilities of an existence of anomalies, and, for the encoded S206 state of the medical image using the second auto-encoder, the stored S110 encoded state within the comparison database with the closest probabilities of a non-existence of anomalies from the comparison database.

The method 200 further includes a step S210 of assigning, based on the probabilities of an existence and non-existence of anomalies of the determined S208 stored S110 encoded states, an existence and non-existence of anomalies to the received S202 medical image.

The method 200 may further include a step (not shown) of outputting (e.g., on a graphical user interface, GUI, and/or a display) the assigned existence and non-existence of anomalies in relation to the received S202 medical image.

FIG. 3 schematically depicts a flowchart for a method of training a downstream NN for performing anomaly detection in medical images received from a medical scanner (e.g. using the method 200 of FIG. 2). The method is referred to by the reference sign 300.

The method 300 includes a step S302 of receiving an annotation as Ground Truth in relation to a medical image, which is received S202 (e.g., the medical image and annotation are included in a training dataset received from a stored training database). Subsequently, the anomaly detection algorithm is performed, S204, the medical image is encoded S206 twice (e.g., without the condition of the selectivity in the training phase and/or for all medical images, irrespective of the result of the anomaly detection algorithm being non-decisive or decisive). The stored S110 encoded states within the comparison database are determined, and existences and non-existences of anomalies are assigned S210. In the training phase, the assigned S210 existences and non-existences of anomalies are compared with the received S302 Ground Truth in a step S310. The comparison may, e.g., include determining at least one value of a loss function. Training the downstream NN may include optimizing the loss function, e.g., by modifying the step 204 of performing the anomaly detection algorithm and/or the step S208 of determining the stored S110 encoded states with the closest probabilities.

The methods 200 and 300 may be performed by a (for example the same) downstream NN.

FIG. 4 schematically depicts an architecture of a computing device for generating a comparison database for use in a downstream NN for anomaly detection in medical images received from a medical scanner. The computing device is referred to by the reference sign 400.

The computing device 400 includes a medical image reception interface 404 configured for receiving a set of medical images. Each medical image within the set includes an annotation.

The computing device 400 further includes a filtering module 406 configured for filtering the received set of medical images for a subset of medical images with a decisive detection of an existence and non-existence of anomalies for a set of anomaly classes. The decisive detection is determined by an anomaly detection algorithm congruently with the received annotation.

The computing device 400 further includes a (e.g., second) augmenting module 408 configured for augmenting the filtered set of medical images by optimizing a distance between encoded states of pairs of medical images within the filtered set.

The (e.g., second) augmenting module 408 includes a first (e.g., auto-) encoder-decoder interface 408-1 to a first (e.g., auto-) encoder-decoder configured for maximizing the distance for positive pairs of medical images having the same decisively detected existence and non-existence of anomalies before encoding and/or after decoding the encoded state. The (e.g., second) augmenting module 408 further includes a second (e.g., auto-) encoder-decoder interface 408-2 to a second (e.g., auto-) encoder-decoder configured for minimizing the distance for negative pairs of medical images having disjoint decisively detected existences of anomalies before encoding and/or after decoding the encoded state.

The first (e.g., auto-) encoder-decoder interface 408-1 and the second (e.g., auto-) encoder-decoder interface 408-2 may be jointly embodied by an (e.g., auto-) encoder-decoder interface 408-A.

Augmenting the filtered set of medical images may further include determining a probability of an existence or non-existence of an anomaly for each anomaly class from the decoding of the encoded state.

The computing device 400 further includes a computer-readable storage (also: memory) 410 configured for storing the encoded states of the augmented set of medical images along with the determined probabilities of existences and non-existences of anomalies as a generated comparison database.

Optionally, the computing device 400 includes a first augmenting module 402 configured for augmenting the set of medical images. The augmenting of the set of medical images may include, for any medical image within the set adding noise, and/or performing at least one geometric transformation. The at least one geometric transformation may include flipping the medical image (e.g., horizontally and/or vertically), rotating the medical image (e.g., by 90 degrees), cropping the medical image, and/or re-scaling the medical image.

The filtering module 406 may include an anomaly detection algorithm applying module 406-1 configured for applying the anomaly detection algorithm to each received medical image within the set. The applied anomaly detection algorithm may determine a probability of an existence or non-existence of an anomaly for each anomaly class within a predetermined set of anomaly classes.

The filtering module 406 may alternatively or in addition include a first selectively retaining module 406-2 configured for selectively retaining each medical image if the determined probability of the applied anomaly detection algorithm is decisive. The probability being decisive may include, for each anomaly class within the predetermined set of anomaly classes, a probability of the existence of an anomaly above and/or at a predetermined high threshold (e.g., at least and/or above 95%). The probability being decisive may alternatively or in addition include, for each anomaly class within the predetermined set of anomaly classes, a probability of the non-existence of an anomaly below and/or a predetermined low threshold (e.g., at most and/or below 5%).

The filtering module 406 may alternatively or in addition include a comparing module 406-3 configured for comparing, for each retained medical image, the detected existences and non-existences of anomalies for each anomaly class within the predetermined set of anomaly classes with the received annotation.

The filtering module 406 may alternatively or in addition include a second selectively retaining module 406-4 configured for selectively retaining each medical image, for which the result of the comparing is consensual for each anomaly class.

The filtering module 406 may alternatively or in addition include a grouping module 406-5 configured for optionally grouping the retained medical images according to their detected existences and non-existences of anomalies into positive pairs of identical decisively detected existences of one or more anomalies.

The computing device 400 may include at least one processor 412. The optional first augmenting module 402, the filtering module 406, and/or the (e.g., second) augmenting module 408 may be embodied by the at least one processor 412.

The computing device 400 may include an input-output interface 414. The medical image reception interface 404, the first (e.g., auto-) encoder-decoder interface 408-1, the second (e.g., auto-) encoder-decoder interface 408-2, and/or the (e.g., auto-) encoder-decoder interface 408-A may be embodied by the input-output interface 414.

The computing device 400 may be configured for performing the method 100.

FIG. 5 schematically depicts an architecture of a downstream NN for performing anomaly detection in medical images received from a medical scanner using the comparison database, which may, e.g., be generated by the method 100 of FIG. 1 and/or by the computing device 400 of FIG. 4. The downstream NN is generally referred to by the reference sign 500.

The downstream NN 500 includes a medical image reception interface 502 configured for receiving a medical image from a medical scanner (and/or in a training phase from a storage of a training database).

The downstream NN 500 further includes an anomaly detection algorithm performing module 504 configured for performing the anomaly detection algorithm on the received medical image.

The downstream NN 500 further includes a first interface 506-1 to the first (e.g., auto-) encoder-decoder and a second interface 506-2 to the second (e.g., auto-) encoder-decoder. The first interface 506-1 and the second interface 506-2 are configured for receiving a selectively encoded medical image from the first (e.g., auto-) encoder-decoder and the second (e.g., auto-) encoder-decoder, respectively. The selectively encoding is performed (e.g., only, and/or in an inference phase) if a result of performing the anomaly detection algorithm is non-decisive.

In an alternative embodiment, the downstream NN 500 includes the first (e.g., auto-) encoder-decoder and the second (e.g., auto-) encoder-decoder.

The first interface 506-1 and the second interface 506-2 may be embodied by one or more (e.g., auto-) encoder-decoder interfaces 506.

The downstream NN 500 further includes a closest encoded state determining module 508 configured for determining, for the encoded state of the medical image using the first auto-encoder, the stored encoded state within the comparison database with the closest probabilities of an existence of anomalies, and, for the encoded state of the medical image using the second auto-encoder, the stored encoded state within the comparison database with the closest probabilities of a non-existence of anomalies from the comparison database.

The downstream NN 500 further includes an anomaly existence assignment module 510 configured for assigning, based on the probabilities of an existence and non-existence of anomalies of the determined stored encoded states, an existence and non-existence of anomalies to the received medical image.

The downstream NN 500 may further include a memory 516, e.g., for storing the generated comparison database.

E.g., for use in the training phase, the downstream NN 500 may include an annotation reception interface 502-A configured for receiving an annotation as Ground Truth in relation to each medical image used for the training.

Alternatively or in addition, e.g., for use in the training phase, the downstream NN 500 may include a Ground Truth comparison module 510-C configured for comparing the assigned existence and non-existence of anomalies with the Ground Truth.

The downstream NN 500 may include at least one processor 512. The anomaly detection algorithm performing module 504, closest encoded state determining module 508, anomaly existence assignment module 510, and/or the optional Ground Truth comparison module 510-C may be embodied by the at least one processor 512.

The downstream NN 500 may include an input-output interface 514. The medical image reception interface 502, annotation reception interface 502-A, first interface 506-1 to the first (e.g., auto-) encoder-decoder, and/or second interface 506-2 to the second (e.g., auto-) encoder-decoder may be embodied by the input-output interface 514.

Alternatively or in addition, the input-output interface 514 may be configured for outputting the assigned existence and non-existence of anomalies to a medical image, e.g., in the inference phase.

The downstream NN 500 may be configured to perform the methods 200 and/or 300.

A system may include the downstream NN 500, the first and second (e.g., auto-) encoder-decoders and an interface to at least one medical scanner (e.g., to a fleet of X-ray scanners).

In an embodiment, the first and second (e.g., auto-) encoder-decoders may be included in the downstream NN 500, with the corresponding first interface 506-1 and second interface 506-2 being internal interfaces of the downstream NN 500.

The system may be configured to perform the methods 200 and/or 300.

The described techniques (e.g., including the methods 100, 200 and 300, the computing device 400, the downstream NN 500, and/or the system) may be used for (and/or may alternatively be denoted as) fuzzy abnormality clarification (e.g., in chest X-rays) using inverse contrastive learning and context anchoring.

The generating of the comparison database may in an example be described in six steps. For concreteness, in the following the medical images include chest X-ray images, and the set of anomaly classes includes pneumonia, a mass (and/or tumor), atelectasis, consolidation, edema, emphysema and fibrosis. It is noted that this type of medical images and set of anomaly classes is provided only as illustrative example and does not limit the embodiments thereto.

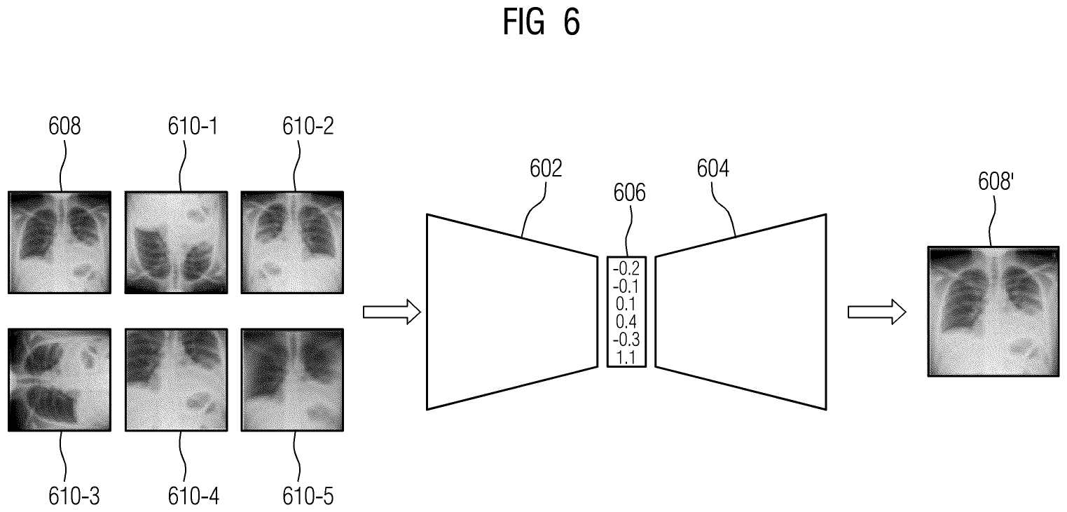

In a first step, given a set of medical (e.g., X-ray) images 608, an (e.g., auto-) encoder-decoder network, including an encoder 602 and decoder 604 as schematically illustrated in FIG. 6, may be trained to encode and then decode the same medical image. Augmentations specific to the set of medical (e.g. X-ray) images 608 may be applied, and the encoding/decoding process repeated. As schematically illustrated in FIG. 6, the original medical image 608 may be geometrically transformed by a vertical or horizontal flip, a rotation (e.g., by 90 degree), cropping and/or re-scaling, resulting in the geometrically transformed medical images 610-1; 610-2; 610-3; 610-4 and/or 610-5, respectively.

The augmentations (e.g., including the geometric transformations and/or adding noise to the original image 608) may be subject to a hyper parameter tunning for determining the optimal size of the encoded state 606.

In a second step, the complete (and/or augmented) dataset may undergo encoding. Subsequently, for each medical (e.g., X-ray) image 608, a set of (e.g., p) other images 608-A; 608-B; 608-C may be chosen based on the closest matching decoding output 608′-A; 608′-B; 608′-C of their respective encoded states 606, with the original medical (e.g., X-ray) image 608.

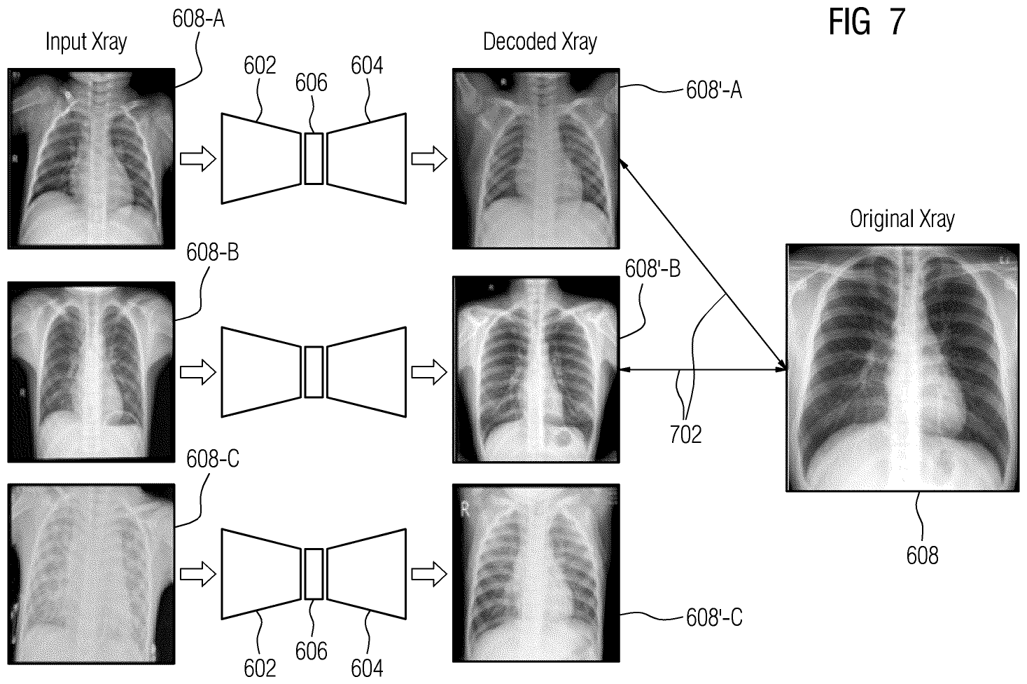

FIG. 7 schematically depicts the matching of similar medical (e.g., X-ray) images based on their encoded states (also denoted as: determining the medical images with the closest probabilities of existences and/or non-existences of anomalies; briefly: determining the closest medical images).

As schematically depicted in FIG. 7, choosing 702 the closest matching decoding output 608′-A; 608′-B, based on the closest probabilities of an existence and non-existence of anomalies, may generate positive-to-positive (briefly: positive) pairs of medical (e.g., X-ray) images under the presumption that if they are similar, their respective encoded states 606 should be interconvertible (and/or have the same assignments of existences and non-existences of anomalies within the set of anomaly classes).

E.g., the decoded medical images 608′-A and 608′-B may each be indicative (and/or have a decisive probability) of pneumonia as an anomaly. Only the decoded medical image 608′-C may be indicative of an abnormal mass (or vice versa for the existences of anomalies in the images 608′-A; 608′-B vs. 608′-C).

In a third step, the dataset may be filtered for human-machine prediction agreement (and/or the decisive determination of an existence and non-existence of anomalies by an anomaly detection algorithm being congruent, and/or in agreement, with an annotation, which has, e.g., been performed manually by a medical practitioner).

An anomaly (also: abnormality) detection algorithm is applied to each medical image (e.g., labeled as xk with k=1, 2, . . . ) within the complete (augmented, and/or comprehensive) dataset. The abnormality detection algorithm is applied to the original non-encoded medical image 608; 608-A; 608-B; 608-C (and/or to the decoded medical image 608′; 608′-A; 608′-B; 608′-C).

Subsequently, medical images are selectively retained with decisive detection (also: decisive probabilities and/or decisive predictions), indicating those with a high probability (e.g., ≥95%) of detected abnormalities and low probabilities (e.g., ≤5%) associated with all non-detected abnormalities.

Table 1 provides sample numbers of probabilities (expressed as fractions of 1) for two medical images x1 and x2, which form a positive pair. Both medical images x1 and x2 have a decisive determination of an existence of pneumonia and an (for example abnormal) mass (e.g., with high probabilities ranging from 95% to 98%). Additionally, both medical images x1 and x2 have a decisive determination of a non-existence of a consolidation, edema, emphysema and fibrosis (e.g., with low probabilities ranging from 1% to 5%).

TABLE 1
Exemplary positive pair with probabilities of (non-) existences of anomalies

| x1 | Pneumonia | Mass | Atelectasis | Consolidation | Edema | Emphysema | Fibrosis |
|---|---|---|---|---|---|---|---|
| | 0.96 | 0.97 | 0.01 | 0.03 | 0.05 | 0.05 | 0.04 |
| x2 | Pneumonia | Mass | Atelectasis | Consolidation | Edema | Emphysema | Fibrosis |
| | 0.98 | 0.95 | 0.04 | 0.01 | 0.05 | 0.03 | 0.01 |

The determinations of existence and non-existences of anomalies in Table 1 are thus decisive for every single anomaly class (e.g., pneumonia, mass, atelectasis, consolidation, edema, emphysema, fibrosis).

The (for example decisive) results of the anomaly detection algorithm (briefly also: automated results) may subsequently be juxtaposed with the accurate human-detected labels (and/or the annotations). Those instances that do not exhibit a perfect correspondence (e.g., in terms of determining existences and non-existences of anomalies, for example without a need of probability values included in the annotations) may be removed. The steps of juxtaposing the automated results with the annotations and removing the medical image (e.g., x1 or x2 in Table 1) in case of a non-correspondence (also: lack of congruence) culminates in the formation of a data subset, in which both the anomaly detection algorithm and the human annotators concur with pinpoint accuracy.

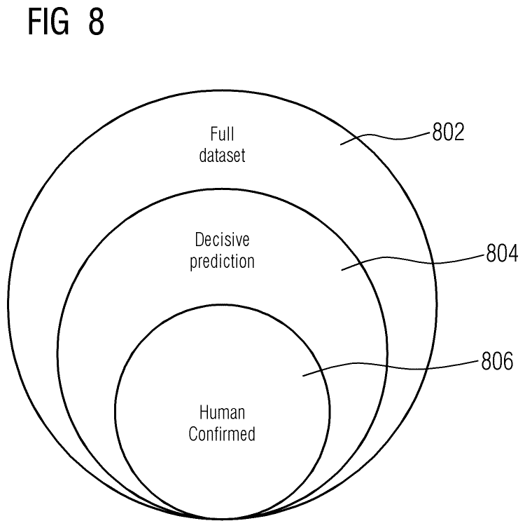

FIG. 8 schematically depicts the sequential filtering of a set 802 of medical (e.g., X-ray) images based on decisive abnormalities probabilities (and/or decisive determinations of the existence and non-existence of anomalies), resulting in the first filtered subset 804, and human confirmation (and/or, for example congruent, annotation), resulting in the second filtered subsect 806.

In a fourth step, a group of positive-positive (briefly: positive) medical images (and/or positive medical image pairs) may be created.

The (for example filtered) subset (and/or data) acquired in the second and third step may be intersected during positive pair distillation. In a first sub-step of the fourth step, for every group of (e.g., p and/or positive) medical images obtained in the second step, only a group including at least two medical images with decisive predictions from the third step are retained.

In a second sub-step of the fourth step, from the selected group, only those medical images sharing identical abnormality labels (and/or identical existences and non-existences of anomalies for all anomaly classes, e.g., without a need for an identical decisive probability value) are retained.

Consequently, multiple subsets of positive medical images have been generated characterized by two attributes. Firstly, all medical images within each subset share congruent labels (and/or the same existences and non-existences of anomalies for all anomaly classes). Secondly, from a decoding perspective, all medical images within each subset are interconvertible (and/or all encoded states are interconvertible). Interconvertible may mean that the encoded states within the subset correspond to the same set of decisively detected existences and non-existences of anomalies.

In a fifth step, inverse contrastive learning is performed using a minimal sufficient representation (and/or encoded state) for positivity.

A more refined phase of (e.g., fine) tuning the encoder-decoder architecture aims (e.g., specifically) at generating a “minimal sufficient representation”, which is tailored explicitly for the anomaly (also: abnormality) detection task, as exemplified by the decisive anomaly detection results in Table 1.

Given a pair of (e.g., positive) medical images, e.g., denoted as x1 and x2, their encoded representations (also: encoded states) may be denoted, e.g., as v1 and v2, respectively. Subsequently, an abnormality detection training may be performed (and/or engaged in) using the decoded outputs, e.g., of v1 and v2. Simultaneously, it may be aimed at (and/or strived to) maximizing the separation (e.g., in terms of a similarity metric such as MSE) between the encoded states, e.g., v1 and v2. The pursuit of maximizing the distance between the encoded states, e.g. v1 and v2, may be bounded by the condition that at least one decoded output exhibits the slightest deviation from the original decisive prediction combination. Alternatively or in addition, maximizing the distance between (and/or generating new) encoded states may be subject to the condition that their decoded representation includes an identical set of decisively determined existing and non-existing anomalies (e.g., except for a numerical change of the probabilities within the predetermined high and low thresholds, e.g., between 95% and 100% for an existence and between 0% and 5% for a non-existence, for example independently and/or separately per anomaly within the set of anomaly classes).

This approach may be referred to as “inverse contrastive learning for positive pairs”. It may be termed “inverse” because it does not aim at minimizing the distance between the encoded states of positive pairs (also: positive pairs of encoded states), as is typical in conventional approaches. Instead, it seeks to maximize this distance between positive pairs of encoded states, subject to the constraint of not compromising the abnormality detection task's effectiveness (and/or not changing for which anomalies within the class of anomalies an existence is determined, and for which other anomalies within the class of anomalies a non-existence is determined).

In the fifth step, a “minimal sufficient representation” of the encoded states of all positive pairs in the dataset may be obtained (and/or achieved) ensuring at the same time encoding interconvertibility and prediction clarity. Essentially, a model (e.g., including the first and second (e.g., auto-) encoder-decoders and/or the downstream NN 500) is learning to identify commonalities (e.g., in terms of a decisively determined existence and non-existence of an anomaly for every anomaly class within a set of anomaly classes) between two medical images given a maximal discrepancy outside the commonalities (e.g., a maximal dissimilarity between the encoded states, e.g., a maximal MSE).

In a sixth step, inverse contrastive learning is performed using minimal sufficient representation (and/or encoded state) for negativity.

For each medical image retained after filtering in the third step, negatives may be looked at (and/or determined). A negative may be a medical image with completely different detected abnormalities (for example differing in the existence of an anomaly for every single anomaly class).

Table 2 provides an example of two medical images x3 and x4 forming a negative pair. The first medical image is indicative of a decisive detection of edema and emphysema as anomalies. The second medical image is indicative of a decisive detection of a (e.g., abnormal) mass and atelectasis as anomalies. Both medical images x3 and x4 have decisively determined no anomalies w.r.t. pneumonia, consolidation and fibrosis.

TABLE 2
Exemplary negative pair with probabilities of (non-) existences of anomalies

| x3 | Pneumonia | Mass | Atelectasis | Consolidation | Edema | Emphysema | Fibrosis |
|---|---|---|---|---|---|---|---|
| | 0.03 | 0.03 | 0.00 | 0.04 | 1.00 | 0.97 | 0.01 |
| x4 | Pneumonia | Mass | Atelectasis | Consolidation | Edema | Emphysema | Fibrosis |
| | 0.00 | 0.97 | 0.96 | 0.03 | 0.01 | 0.01 | 0.02 |

For each negative pair, inverse contrastive learning may be applied.

Given a pair of negative medical images, e.g., denoted as x3 and x4, their encoded representations (also: encoded states) may be denoted (and/or derived) as v3 and v4, respectively. Subsequently, an abnormality detection training may be performed (and/or engaged in) using the decoded outputs of the encoded states, e.g., v3 and v4. Simultaneously, it may be aimed at (and/or strived to) minimizing the separation between the encoded states, e.g., v3 and v4. The pursuit of minimizing the distance between the encoded states, e.g., v3 and v4, ma be bounded by the condition that at least one decoded output produces an abnormality already present in the other negative image of the pair. Alternatively or in addition, minimizing the distance between (and/or generating new) encoded states may be subject to the condition that their decoded representation includes a disjoint set of decisively determined existing and non-existing anomalies (e.g., except for a numerical change of the probabilities within the predetermined high and low thresholds, e.g., between 95% and 100% for an existence and between 0% and 5% for a non-existence, for example independently per anomaly within the set of anomaly classes).

In the case of negatives (and/or negative pairs), the “minimal sufficient representation” allows for just as much encoding similarity so that the two negatives still differ in whatever abnormalities are present but at the same time are similar (e.g., up to a small number of disjoint existences of abnormalities) in what abnormalities are missing. Essentially, the model (e.g., including the first and second (e.g., auto-) encoder-decoders and/or the downstream NN 500) is learning what are the discrepancies between two medical images, regardless of how close those discrepancies might seem to appear.

The fifth and sixth step may be disjoint (and/or may be performed independently), each representing (and/or corresponding to) a different (e.g., auto-) encoder-decoder architecture, the first one for identifying commonalities in abnormalities (and/or the same decisively detected existence and non-existence of anomalies), the second one for identifying commonalities in absent abnormalities (and/or disjoint decisively detected existences of anomalies before encoding and/or after decoding of the encoded state). Both comparisons may be performed with respect to a glossary of previously selected medical imaging (e.g., radiology) reports with clear (and/or decisive) probability labels (and/or annotations).

In the following, an exemplary medical imaging (e.g., radiology) report hierarchy (and/or a medical imaging report workflow, e.g., a radiology report workflow) according to the technique is described.

Given the two (e.g., auto-) encoder-decoder architectures (e.g., for abnormalities similarity and lack of abnormalities similarity, respectively), the entire dataset (and/or set of medical images) may be encoded twice, and distances may be determined (e.g., computed) between the encoded states. As such, two distance matrices, one for abnormalities, the other for absence of abnormalities may be created.

At inference time, a medical image (e.g., a radiology image) with weak and/or confusing probabilities (e.g., a probability for one anomaly class below the high threshold and above the low threshold, e.g., between 5% and 95%) may be encoded by the first (e.g., auto-) encoder (also: similarity encoder) and compared against the (e.g., k) closest medical images (also: base images) from the glossary, once for present abnormalities and again for missing abnormalities. Alternatively or in addition, the medical image with weak and/or confusing probabilities may be encoded by the second (e.g., auto-) encoder (also: dissimilarity encoder) and compared against the (e.g., k′) closest medical images (also: base images) from the glossary, once for present abnormalities and again for missing abnormalities.

Medical image (e.g., radiology) findings may be used as guidance for a fuzziness resolution.

Once double sets of (e.g., k and/or k′) clear medical imaging (e.g., radiology) reports have been identified that may guide in discerning what abnormalities are present and which are missing in a fuzzy medical (e.g., radiology) image, they may be used to train an (e.g., natural language processing, NLP) model for medical imaging (e.g., radiology) findings.

Specifically, a large language model (LLM) may be tuned to take as input three medical (e.g., radiology) image findings, the fuzzy image medical (e.g., radiology) finding, findings for the image closest in abnormalities to the fuzzy image, and findings for the image closest in lack of abnormalities to the fuzzy image.

Given the three inputs (and/or the findings) and an additional fourth input representing the fuzzy probabilities of the fuzzy image, the LLM must (or should) give a definitive answer about those abnormalities whose probabilities are not definitive.

The described technique makes use of at least two original aspects.

A method called “inverse contrastive learning” is used as a two-step approach to select minimally similar and minimally dissimilar pairs of medical images (and/or their encoded states), denoted respectively as positive and negative pairs. The technique is inverse to the conventional contrastive learning method, where a positive pair distance is minimized, and a negative pair distance is maximized. The inverse technique is based on the “minimal sufficient representation” principle.

Definitive (also: decisive) classified examples are used as guidance for fuzzy predictions, both in determining similarities and differences (and/or the same and disjoint existences of anomalies, respectively).

The medical imaging (e.g., radiology) findings may be used for similar and dissimilar medical images as inputs for a large language model (LLM), in order to generate the response for an abnormality classification task, alongside the original medical imaging (e.g., radiology) finding for the medical image under study (and/or examination).

The described technique may be detected, e.g., by a training objective for positive-positive (briefly: positive) and negative-negative (briefly: negative) pair selection of medical (e.g., X-ray) images. Any approach that tries to maximize the distance between similar images till failure (e.g., of a detection of the existence of an anomaly and/or of a detection of a non-existence of an anomaly) or to minimize the distance between dissimilar images until failure (e.g., of a detection of the existence of an anomaly and/or of a detection of a non-existence of an anomaly) may indicate the use of the technique, for example in an unorthodox way contrary to the conventional contrastive learning approach.

Alternatively or in addition, the use of medical imaging (e.g., radiology) findings corresponding to definitive classified images as anchors for fuzzy image classification may also indicate a possible infringement.

Augmenting the set of medical images by adding noise and/or performing at least one geometric transformation may include adding random noise (e.g., as described in https://scikit-image.org/docs/stable/api/skimage.util.html #skimage.util.random_noise, the content of which is included herein by reference) and/or adding radiation specific noise (e.g., as described in https://en.wikipedia.org/wiki/Speckle_(interference), the content of which is included herein by reference). Alternatively or in addition, augmenting the set of medical images may include the method described by A. D. Dinescu et al. in “X CAE: Deep Neural Network for X-ray Coronary Angiograms Quality Enhancement”, 2023 IEEE 28th International Conference on Emerging Technologies and Factory Automation (ETFA), pages 1-6, the content of which is included herein by reference.

A similarity measure for a medical (e.g., X-ray) image may include PSNR, SSIM, BRISQUE, NIQE, and/or DISTS.

PSNR and SSIM may both be used to compare the similarity between medical (e.g., radiology) images. SSIM is conventionally preferred over PSNR for medical imaging tasks because it takes into account structural similarity in addition to pixel-wise differences, making it more suitable for assessing the clinical relevance of the images (e.g., in terms of anatomical structures and/or organs).

BRISQUE and NIQE are both no-reference image quality assessment metrics that may be used to evaluate the quality of medical (e.g., radiology) images without requiring a reference image. They analyze natural scene statistics to assess image quality and may provide valuable insights into the perceptual quality of medical (e.g., radiology) images.

DISTS is a deep learning-based metric that measures structural similarity between images and may be used to compute similarity between medical (e.g., radiology) images. It leverages convolutional neural networks (CNNs) to capture complex image features and provide a more sophisticated assessment of similarity compared to traditional metrics like SSIM.

Independent of the grammatical term usage, individuals (e.g., medical practitioners and/or patients) with male, female or other gender identities are included within the term.

Wherever not already described explicitly, individual embodiments, or their individual aspects and features, described in relation to the drawings may be combined or exchanged with one another without limiting or widening the scope of the embodiment, whenever such a combination or exchange is meaningful. Advantages which are described with respect to a particular embodiment or with respect to a particular figure are, wherever applicable, also advantages of other embodiments.

1. A computer-implemented method for generating a comparison database for use in a downstream neural network for anomaly detection in medical images received from a medical scanner, the method comprising:
receiving a set of medical images, wherein each medical image within the set of medical images comprises an annotation;
filtering the set of medical images for a subset of medical images with a decisive detection of an existence and non-existence of anomalies for a set of anomaly classes, wherein the decisive detection is determined by an anomaly detection algorithm congruently with the annotation;
augmenting the filtered set of medical images using a first auto-encoder-decoder and a second auto-encoder-decoder by optimizing a distance between encoded states of pairs of medical images within the filtered set, wherein the optimizing of the distance of the encoded states comprises:
maximizing, using the first auto-encoder-decoder, a distance for positive pairs of medical images having the same decisively detected existence and non-existence of anomalies before encoding and/or after decoding the encoded state;
minimizing, using the second auto-encoder-decoder, a distance for negative pairs of medical images having disjoint decisively detected existences of anomalies before encoding and/or after decoding the encoded state; and
determining a probability of an existence or non-existence of an anomaly for each anomaly class from the decoding of the encoded state; and
storing, in the comparison database, the encoded states of the augmented set of medical images along with the probabilities of existences and non-existences of anomalies.

2. The computer-implemented method of claim 1, further comprising:
augmenting the set of medical images, wherein the augmenting comprises, for any medical image within the set:
adding noise, and/or
performing at least one geometric transformation selected from a group of: flipping the medical image horizontally, flipping the medical image vertically, rotating the medical image by 90 degrees, cropping the medical image, or scaling the medical image.

3. The computer-implemented method of claim 1, wherein filtering the received set of medical images comprises:
applying the anomaly detection algorithm to each received medical image within the set of medical images, wherein the applied anomaly detection algorithm determines a probability of an existence or non-existence of an anomaly for each anomaly class within a predetermined set of anomaly classes;
selectively retaining each medical image if the determined probability of the applied anomaly detection algorithm is decisive, wherein the probability being decisive comprises, for each anomaly class within the predetermined set of anomaly classes:
a probability of the existence of an anomaly at and/or above a predetermined high threshold; and
a probability of the non-existence of an anomaly at and/or below a predetermined low threshold;
comparing, for each retained medical image, the detected existences and non-existences of anomalies for each anomaly class within the predetermined set of anomaly classes with the received annotation; and
selectively retaining each medical image, for which a result of the comparing is consensual for each anomaly class.

4. The computer-implemented method of claim 3, further comprising:
grouping the retained medical images according to their detected existences and non-existences of anomalies into positive pairs of identical decisively detected existences of one or more anomalies.

5. The computer-implemented method of claim 1, wherein augmenting the filtered set of medical images comprises training the first auto-encoder-decoder and the second auto-encoder-decoder for optimizing the distances between the encoded states of each pair.

6. The computer-implemented method of claim 1, wherein the medical images are two-dimensional, 2D, images, and/or 2D slices of volumetric images.

7. The computer-implemented method of claim 1, wherein the distance between encoded states is determined by a similarity metric between the pairs of encoded states.

8. The computer-implemented method of claim 7, wherein the similarity metric comprises a mean squared error.

9. The computer-implemented method of claim 1, further comprising:
performing, by a downstream neural network, anomaly detection in medical images received from the medical scanner using the comparison database, the performing comprising:
receiving a medical image;
performing the anomaly detection algorithm on the received medical image;
selectively encoding the medical image twice using the first auto-encoder-decoder and the second auto-encoder-decoder, wherein the selectively encoding is performed if a result of performing the anomaly detection algorithm is non-decisive;
wherein for an encoded state of the medical image using a first auto-encoder of the first auto-encoder-decoder, determining the stored encoded state within the comparison database with the closest probabilities of an existence of anomalies, and for the encoded state of the medical image using a second auto-encoder of the second auto-encoder-decoder, determining the stored encoded state within the comparison database with the closest probabilities of a non-existence of anomalies from the comparison database;
wherein based on the probabilities of an existence and non-existence of anomalies of the determined stored encoded states, assigning an existence and non-existence of anomalies to the received medical image.

10. The computer-implemented method of claim 9, further comprising:
training the downstream neural network for performing anomaly detection in medical images received from the medical scanner, wherein in a training phase, in the step of receiving the medical image, annotations in a relation to the medical image are received as Ground Truth, and wherein the assigned existence and non-existence of anomalies to the received medical image is further compared with the received Ground Truth, and wherein the comparing comprises determining at least one value of a loss function, wherein training the downstream neural network comprises optimizing the at least one value of the loss function.

11. The computer-implemented method of claim 9, wherein the first auto-encoder-decoder is trained for maximizing a distance of positive pairs of medical images, for which the same existence and non-existence of anomalies for any anomaly class within a set of anomaly classes has been decisively detected before encoding and/or after decoding the encoded states.

12. The computer-implemented method of claim 9, wherein the second auto-encoder-decoder is trained for minimizing a distance of negative pairs of medical images, for which disjoint existences of anomalies have been decisively detected before encoding and/or after decoding the encoded state.

13. A computing device for generating a comparison database for use in a downstream neural network for anomaly detection in medical images received from a medical scanner, the computing device comprising:
a medical image reception interface configured for receiving a set of medical images, wherein each medical image within the set comprises an annotation;
a filtering module configured for filtering the received set of medical images for a subset of medical images with a decisive detection of an existence and non-existence of anomalies for a set of anomaly classes, wherein the decisive detection is determined by an anomaly detection algorithm congruently with the received annotation;
an augmenting module configured for augmenting the filtered set of medical images by optimizing a distance between encoded states of pairs of medical images within the filtered set, wherein the augmenting module comprises:
a first auto-encoder-decoder interface to a first auto-encoder-decoder configured for maximizing a distance for positive pairs of medical images having the same decisively detected existence and non-existence of anomalies before encoding and/or after decoding the encoded state; and
a second auto-encoder-decoder interface to a second auto-encoder-decoder configured for minimizing a distance for negative pairs of medical images having disjoint decisively detected existences of anomalies before encoding and/or after decoding the encoded state;
wherein the augmenting further comprises determining a probability of an existence or non-existence of an anomaly for each anomaly class from the decoding of the encoded state; and
a computer-readable storage configured for storing the encoded states of the augmented set of medical images along with the determined probabilities of existences and non-existences of anomalies as a generated comparison database.

14. The computing device of claim 13, wherein the downstream neural network for performing anomaly detection in medical images received from the medical scanner using the comparison database comprises:
the medical image reception interface configured for receiving a medical image;
an anomaly detection algorithm performing module configured for performing the anomaly detection algorithm on the received medical image;
a first interface to the first auto-encoder-decoder and a second interface to the second auto-encoder-decoder, wherein the first interface and the second interface are configured for receiving a selectively encoded medical image from the first auto-encoder-decoder and the second auto-encoder-decoder, respectively, wherein the selectively encoding is performed if a result of performing the anomaly detection algorithm is non-decisive;
a closest encoded state determining module configured for determining, for the encoded state of the medical image using a first auto-encoder of the first auto-encoder-decoder, the stored encoded state within the comparison database with the closest probabilities of an existence of anomalies, and for the encoded state of the medical image using a second auto-encoder of the second auto-encoder-decoder, the stored encoded state within the comparison database with the closest probabilities of a non-existence of anomalies from the comparison database;
an anomaly existence assignment module configured for assigning, based on the probabilities of an existence and non-existence of anomalies of the determined stored encoded states, an existence and non-existence of anomalies to the received medical image.

15. The computing device of claim 13, wherein the downstream neural network is trained for performing anomaly detection in medical images received from the medical scanner, wherein in a training phase, in the step of receiving the medical image, annotations in a relation to the medical image are received as Ground Truth, and wherein an assigned existence and non-existence of anomalies to the received medical image is further compared with the received Ground Truth, and wherein the comparing comprises determining at least one value of a loss function, wherein training the downstream neural network comprises optimizing the at least one value of the loss function.

16. A system for performing anomaly detection in medical images received from a medical scanner, the system comprising:
a first auto-encoder-decoder trained for maximizing a distance of positive pairs of medical images, for which the same existence and non-existence of anomalies for any anomaly class within a set of anomaly classes has been decisively detected before encoding and/or after decoding an encoded state;
a second auto-encoder-decoder trained for minimizing a distance of negative pairs of medical images, for which disjoint existences of anomalies have been decisively detected before encoding and/or after decoding the encoded state;
a downstream neural network comprising:
a medical image reception interface configured for receiving a medical image;
an anomaly detection algorithm performing module configured for performing the anomaly detection algorithm on the received medical image;
a first interface to the first auto-encoder-decoder and a second interface to the second auto-encoder-decoder, wherein the first interface and the second interface are configured for receiving a selectively encoded medical image from the first auto-encoder-decoder and the second auto-encoder-decoder, respectively, wherein the selectively encoding is performed if a result of performing the anomaly detection algorithm is non-decisive;
a closest encoded state determining module configured for determining, for the encoded state of the medical image using the first auto-encoder, a stored encoded state within a comparison database with the closest probabilities of an existence of anomalies, and for the encoded state of the medical image using the second auto-encoder, the stored encoded state within the comparison database with the closest probabilities of a non-existence of anomalies from the comparison database; and
an anomaly existence assignment module configured for assigning, based on probabilities of an existence and non-existence of anomalies of the determined stored encoded states, an existence and non-existence of anomalies to the received medical image; and
an interface to the medical scanner.
